(19) United States
(12) Patent Application Publication
(10) Pub. No.: US 2019/0082062 A1
(43) Pub. Date: Mar. 14, 2019

(54) NON-TRANSITORY READABLE STORAGE MEDIUM, SETTING METHOD, AND SYSTEM

(71) Applicants: KABUSHIKI KAISHA TOSHIBA, Tokyo (JP); TOSHIBA TEC KABUSHIKI KAISHA, Tokyo (JP)

(72) Inventor: Yuuki Okada, Tagata Shizuoka (JP)

(21) Appl. No.: 15/704,226

(22) Filed: Sep. 14, 2017

(51) Int. Cl. H04N 1/00

(52) U.S. Cl. CPC H04N 1/0097; G06F 17/30; H04N 1/00962; H04N 1/00352

(57) ABSTRACT

In accordance with an embodiment, a non-transitory readable storage medium program is stored. The program enables a processor to receive an input of information indicating a function of an image processing apparatus which is a setting target, acquire parameter information indicating a parameter associated with a function indicated by input information, receive an input of a parameter value indicated by the acquired parameter information, and set the image processing apparatus in response to the input parameter value.

### FIELD

Embodiments described herein relate generally to a non-transitory readable storage medium, a setting method, and a system.

### BACKGROUND

An image forming apparatus has various settings relating to a communication function, security, a printing function, and the like. For example, the image forming apparatus receives an input of parameters for settings from a user via an operation section. An image processing apparatus executes settings based on the input parameters.

The user is required to input necessary parameters without insufficiency. Therefore, conventionally, there is a problem that an input of necessary parameters may be missing.

### DESCRIPTION OF THE DRAWINGS

FIG. 1 is a block diagram exemplifying the constitution of a setting system according to an embodiment;

FIG. 2 is a block diagram exemplifying the constitution of a user terminal according to the embodiment;

FIG. 3 is a block diagram exemplifying the constitution of a server according to the embodiment;

FIG. 4 is a block diagram exemplifying the constitution of an MFP according to the embodiment;

FIG. 5 is a diagram exemplifying the constitution of a parameter table according to the embodiment;

FIG. 6 is a diagram illustrating an example of an input screen on the user terminal according to the embodiment;

FIG. 7 is a diagram illustrating an example of a setting file according to the embodiment;

FIG. 8 is a sequence diagram exemplifying the operation of the setting system according to the embodiment;

FIG. 9 is a flowchart exemplifying the operation of the user terminal according to the embodiment; and

FIG. 10 is a flowchart exemplifying the operation of the user terminal according to the embodiment.

### DETAILED DESCRIPTION

In accordance with an embodiment, a non-transitory readable storage medium program is stored. The program enables a processor to receive an input of information indicating a function of an image processing apparatus which is a setting target, acquire parameter information indicating a parameter associated with a function indicated by input information, receive an input of a parameter value indicated by the acquired parameter information, and set the image processing apparatus in response to the input parameter value.

Hereinafter, an embodiment is described with reference to the accompanying drawings.

A setting system according to the embodiment sets an MFP (an image forming apparatus or an image processing apparatus). In the setting system, a parameter table showing parameters for setting is stored in a server in advance. The setting system acquires a parameter that needs to be set from the server and presents it to a user. The setting system receives an input of the presented parameter from the user to set it in the MFP.

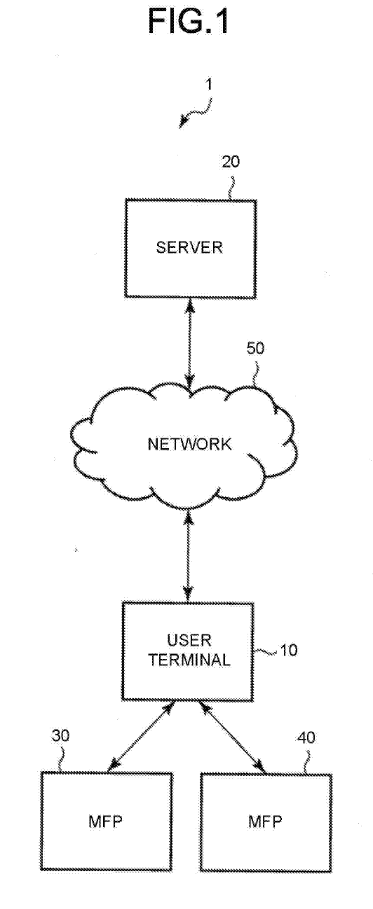

FIG. 1 is a block diagram exemplifying the constitution of a setting system 1 according to the embodiment.

As shown in FIG. 1, the setting system 1 includes a user terminal 10, a server 20, an MFP 30, an MFP 40, and a network 50. The setting system 1 may have a component as necessary in addition to the components as shown in FIG. 1 or exclude a specific component from those components.

The user terminal 10 is a terminal to which the user inputs the parameter. The user terminal 10 is held by the user. The user terminal 10 transmits and receives data to and from the server 20 through the network 50. The user terminal 10 transmits and receives data to and from the MFPs 30 and 40. The user terminal 10 may be a portable terminal such as a smartphone, a tablet PC, a notebook PC, a wearable terminal or a feature phone. The user terminal 10 may be a desktop PC or the like.

The server 20 (information processing apparatus) provides information on the parameter that can be set in the MFP 30 or 40 to the user terminal 10. The server 20 transmits and receives data to and from the user terminal 10 through the network 50.

The MFP 30 is a setting target of the parameter. The MFP 30 scans an original document or prints an image based on an operation from the user. The MFP 30 may perform copying. The MFP 30 transmits and receives data to and from the user terminal 10. For example, the MFP 30 transmits and receives data directly to and from the user terminal 10.

The MFP 40 is the same as the MFP 30.

The network 50 is a communication network for transmitting and receiving data between the user terminal 10 and the server 20. For example, the network 50 is an Internet. The network 50 may be an individual communication network.

Next, the user terminal 10 is described.

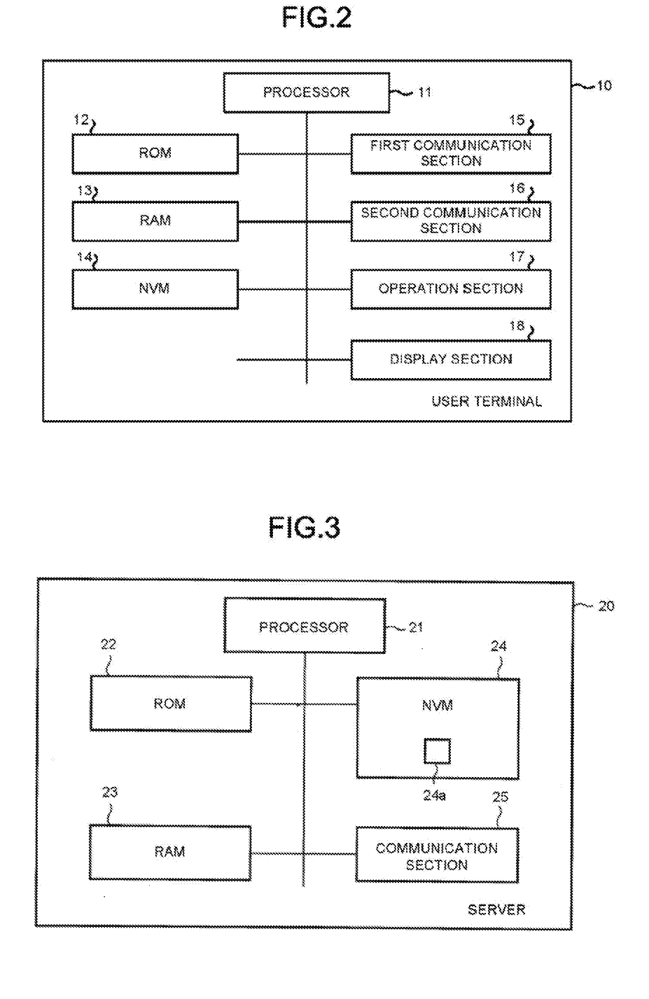

FIG. 2 is a block diagram exemplifying the constitution of the user terminal 10.

As shown in FIG. 2, the user terminal 10 includes, as basic components, a processor 11, a ROM 12, a RAM 13, a NVM 14, a first communication section 15, a second communication section 16, an operation section 17, and a display section 18. These sections are connected with each other via a data bus line. Furthermore, the user terminal 10 may have a component as necessary in addition to the components as shown in FIG. 2 or exclude a specific component from those components.

The processor 11 has a function of controlling the operation of the whole user terminal 10. The processor 11 may include an internal memory and various interfaces. The processor 11 realizes various processing by executing programs stored in the internal memory, the ROM 12 or the NVM 14 in advance.

Furthermore, a part of various functions realized by executing the programs by the processor 11 may be realized through a hardware circuit. In this case, the processor 11 controls the function realized by the hardware circuit.

The ROM 12 is a nonvolatile memory in which a control program and control data are stored in advance. The control program and control data stored in the ROM 12 are incorporated in advance according to specifications of the user terminal 10. The ROM 12 stores, for example, a program for controlling a circuit substrate of the user terminal 10.

The RAM 13 is a volatile memory. The RAM 13 temporarily stores data being processed by the processor 11. The RAM 13 stores various application programs based on a command from the processor 11. Moreover, the RAM 13 may store data necessary for executing the application program and an execution result of the application program.

The NVM 14 (non-transitory readable storage medium) is a nonvolatile memory capable of writing and rewriting data. The NVM 14 is, for example, a hard disk, an SSD, an EEPROM® technology or a flash memory. The NVM 14 stores a program, an application program and various data according to the operation and the application of the user terminal 10.

The first communication section 15 is an interface for transmitting and receiving data to and from the server 20 via the network 50. The first communication section 15 transmits predetermined data to the server 20 in response to a signal from the processor 11. The first communication section 15 transmits the data received from the server 20 to the processor 11.

For example, the first communication section 15 may support LAN connection.

The second communication section 16 is an interface for transmitting and receiving data to and from the MFP 30 or 40. The second communication section 16 transmits predetermined data to the MFP 30 or 40 in response to a signal from the processor 11. The second communication section 16 transmits the data received from the MFP 30 or 40 to the processor 11. The second communication section 16 may directly transmit and receive data to and from the MFP 30 or 40.

The second communication section 16 transmits and receives the data to and from the MFP 30 or 40 in wired or wireless manner. For example, the second communication section 16 may establish an ad hoc communication using LAN connection or the like with the MFP 30 or 40. The second communication section 16 may support Wifi Direct or NFC (Near Filed Communication). The second communication section 16 may support Bluetooth connection or USB connection.

The second communication section 16 may be formed integrally with the first communication section 15.

Various operation instructions are input to the operation section 17 by the user of the user terminal 10. The operation section 17 transmits a signal of an operation instruction input by the user to the processor 11. The operation section 17 is, for example, a keyboard, a numeric keypad or a touch panel.

The display section 18 is a display device that displays various information under the control of the processor 11. The display section 18 is, for example, a liquid crystal monitor or the like. Furthermore, in a case in which the operation section 17 is the touch panel, the display section 18 and the operation section 17 may be integrally formed.

Next, the server 20 is described.

FIG. 3 is a block diagram exemplifying the constitution of the server 20.

As shown in FIG. 3, the server 20 includes, as basic constitution, a processor 21, a ROM 22, a RAM 23, a NVM 24 and a communication section 25. These sections are connected to each other via a data bus line. In addition to the constitution as shown in FIG. 3, the server 20 may have a component as necessary in addition to the components as shown in FIG. 3 or exclude a specific component from those components.

The processor 21 has a function of controlling the operation of the whole server 20.

The ROM 22 is a nonvolatile memory in which a control program and control data are stored in advance.

The RAM 23 is a volatile memory.

The NVM 24 is a nonvolatile memory capable of writing and rewriting data.

The NVM 24 includes a storage area 24a for storing the parameter table. The parameter table is described later.

The communication section 25 is an interface for transmitting and receiving the data to and from the user terminal 10 through the network 50.

The MFP 30 is described.

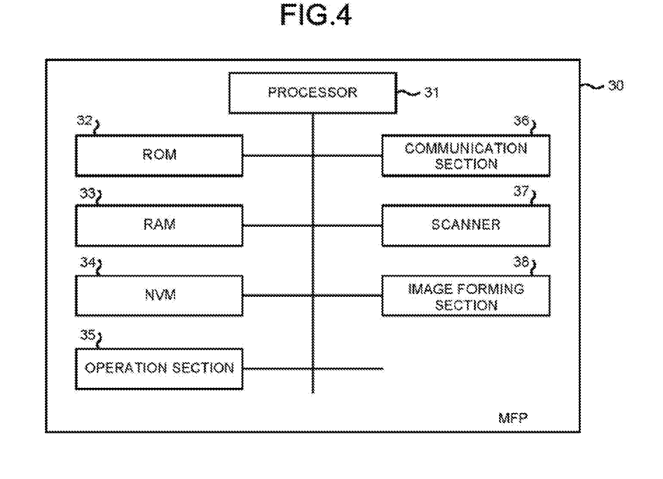

FIG. 4 is a block diagram exemplifying the constitution of the MFP 30.

As shown in FIG. 4, the MFP 30 includes, as basic constitution, a processor 31, a ROM 32, a RAM 33, a NVM 34, an operation section 35, a communication section 36, a scanner 37 and an image forming section 38. These sections are connected to each other via a data bus line. the MFP 30 may have a component as necessary in addition to the components as shown in FIG. 4 or exclude a specific component from those components.

The processor 31 has a function of controlling the operation of the whole MFP 30.

The ROM 32 is a nonvolatile memory in which a control program and control data are stored in advance.

The RAM 33 is a volatile memory. The RAM 33 may temporarily store an image read by the scanner 37 and a copy image transmitted from an external device.

The NVM 34 is a nonvolatile memory capable of writing and rewriting data.

Various operation instructions are input to the operation section 35 by the user of the MFP 30. The operation section 35 transmits a signal of an operation instruction input by the user to the processor 31. The operation section 35 is, for example, a keyboard, a numeric keypad or a touch panel.

The communication section 36 is an interface for transmitting and receiving the data to and from the user terminal 10. The communication section 36 transmits predetermined data to the user terminal 10 in response to a signal from the processor 31. The communication section 36 transmits the data received from the user terminal 10 to the processor 31. The communication section 36 may directly transmit and receive data to and from the user terminal 10.

The communication section 36 transmits and receives the data to and from the user terminal 10 in a wired or wireless manner. For example, the communication section 36 may establish an ad hoc communication with the user terminal 10 using LAN connection or the like. The communication section 36 may support the Wifi Direct or the NFC. The communication section 36 may support the Bluetooth connection or the USB connection.

The scanner 37 reads an image based on a signal from the processor 31. For example, the scanner 37 reads an original document set on a document table of the MFP 30. For example, the scanner 37 may read an original document by moving a sensor group arranged linearly. The scanner 37 may read an original document by moving the original document on the sensor group. The constitution of the scanner 37 is not limited to a specific constitution.

The scanner 37 transmits the read image to the processor 31. The scanner 37 may store the read image in the RAM 33 or an image memory.

The image forming section 38 prints an image on a sheet based on a signal from the processor 31. For example, the image forming section 38 is composed of a sheet feed section for feeding a sheet and a printing section for printing an image on the sheet.

The image forming section 38 takes out the sheet from the sheet section and conveys it to the printing section. The image forming section 38 forms an image on the sheet using the printing section. The printing section, for example, forms an image on the sheet by an electrophotographic system or an inkjet system. If the sheet is thermal paper, the printing section heats the sheet to form an image. The structure of the image forming section 38 is not limited to a specific constitution.

Since the constitution of the MFP 40 is the same as that of the MFP 30, the description thereof is omitted.

The parameter table is described.

The parameter table shows parameters relating to a predetermined function. The parameter table stores a function name indicating the function in association with parameter information on the parameter relating to the function.

The function may be associated with a plurality of parameters. The parameter may be associated with a plurality of functions.

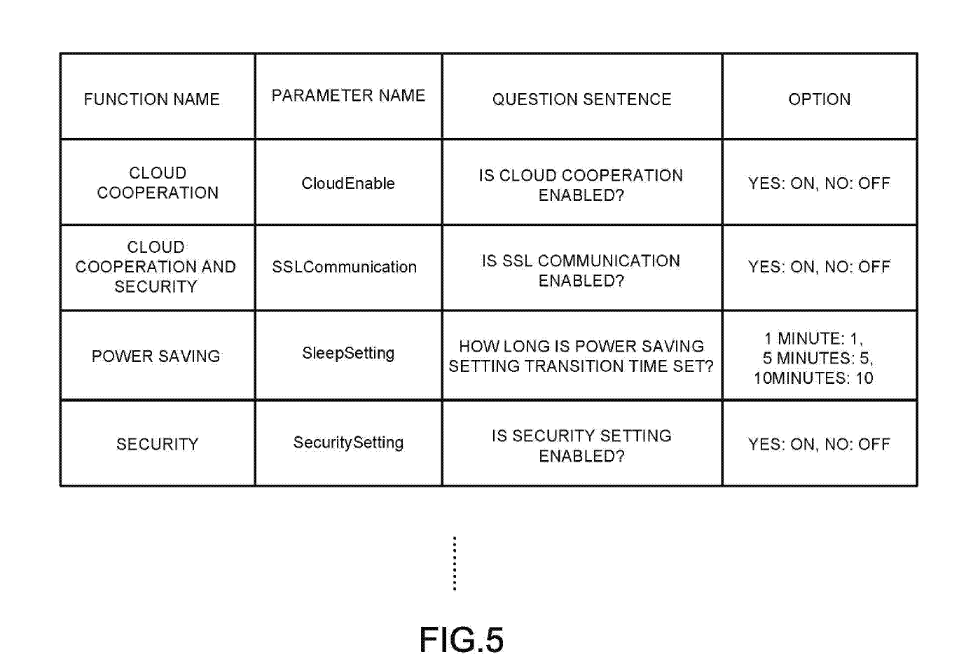

FIG. 5 is a diagram exemplifying the constitution of the parameter table.

As shown in FIG. 5, the parameter table stores the “function name” and the parameter information in association with each other. The parameter information is composed of a “parameter name”, a “question sentence” and an “option”.

The “function name” is a name of the function associated with the parameter. The “function name” may include one or more names.

The “parameter name” indicates the name of the parameter.

The “question sentence” is a sentence presented to the user who inputs the parameter. For example, the “question sentence” indicates a change caused by input of the parameter.

The “option” indicates a value that can be set for the parameter. For example, the “option” stores the option presented to the user in association with a value of the parameter (parameter value). For example, the “option” corresponding to “Cloud Enable” stores “Yes” as an option presented to the user in association with “ON” as the parameter value.

The parameter table is previously stored in the storage area 24a. For example, the parameter table is stored in the storage area 24a by the operation by the user. The processor 21 may store the parameter table acquired through the communication section 25 in the storage area 24a.

The parameter table may be updated as appropriate.

The functions realized by the server 20 are described. The following functions are realized by executing programs stored in the NVM 24 and the like by the processor 21 of the server 20.

The processor 21 has a function of transmitting the parameter information of the parameter associated with a predetermined function to the user terminal 10.

The processor 21 receives a request for requesting the parameter information through the communication section 25. The request includes information indicating the function. For example, the request stores the “function name” as the information indicating the function.

In a case of receiving the request, the processor 21 refers to the parameter table to acquire the parameter information corresponding to the “function name” stored in the request. For example, if the request includes “cloud cooperation” as the “function name”, the processor 21 acquires parameter information of “Cloud Enable” and parameter information of “SSL Communication” from the parameter table.

In a case of acquiring the parameter information, the processor 21 transmits the parameter information acquired as a response to the request to the user terminal 10 through the communication section 25.

The processor 21 may acquire an identifier indicating the function from the user terminal 10 as the information indicating the function. The processor 21 may transmit the parameter information corresponding to the identifier to the user terminal 10.

The function realized by the user terminal 10 is described. The following functions are realized by executing programs stored in the NVM 14 or the like by the processor 11 of the user terminal 10.

First, the processor 11 has a function of receiving an input of the information indicating the function set by the user.

The processor 11 receives the input of the “function name” indicating the function from the user as the information indicating the function. For example, the processor 11 receives an input of the “function name” by displaying an input box on the display section 18.

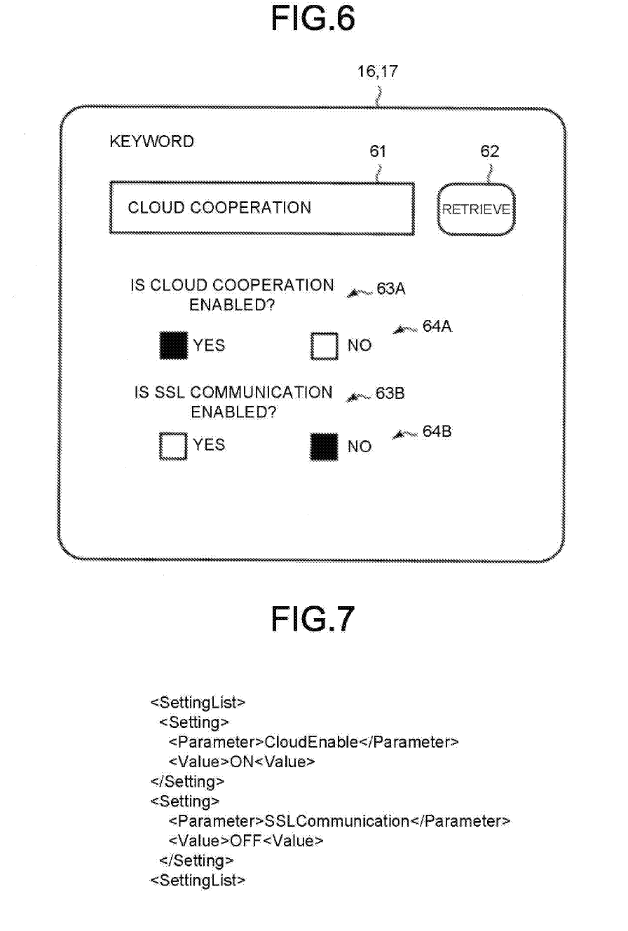

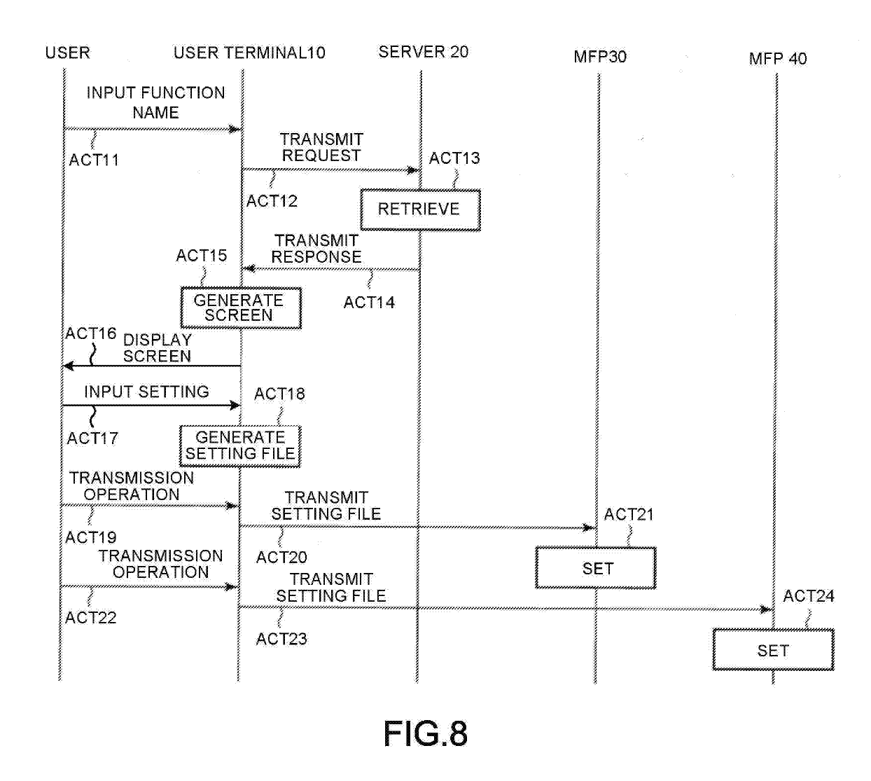

FIG. 6 is a diagram illustrating an example of an input screen such as the “function name”. As shown in FIG. 6, the processor 11 displays an input box 61. The processor 11 acquires a character string input to the input box 61 as the “function name”. In the example shown in FIG. 6, the processor 11 acquires the “cloud cooperation” as “the function name”.

The processor 11 may display a plurality of the function names and receive selection of functions. The processor 11 may acquire an identifier indicating the function as information indicating the function.

In addition, the processor 11 has a function of acquiring the parameter information of the parameter relating to the function set by the user from the server 20.

The processor 11 receives an operation for acquiring the parameter information through the operation section 17. In the example shown in FIG. 6, the processor 11 displays an icon 62 as an icon for receiving the operation to acquire the parameter information. The processor 11 receives an operation for acquiring the parameter information by detecting a tap on the icon 62.

The processor 11 generates a request to acquire the parameter information. The request stores information indicating the function. For example, the request includes the acquired “function name”. The request may include an identifier indicating the function.

The processor 11 transmits the generated request to the server 20 through the first communication section 15.

Through the first communication section 15, the processor 11 receives the parameter information from the server 20 as a response to the request.

The processor 11 has a function of receiving the input of the parameter value in response to the received parameter information.

The processor 11 displays the “question sentence” indicated by the parameter information. The processor 11 displays the “option” indicated by the parameter information. The processor 11 displays options presented to the user.

The processor 11 receives an operation of selecting one option from the user through the operation section 17. The processor 11 acquires the parameter value corresponding to the option.

FIG. 6 is a diagram illustrating an example of the input screen that receives the input of the parameter value. In the example shown in FIG. 6, the processor 11 sets a display area 63 for displaying “question sentence” and a display area 64 for displaying the “option” on the display section 18. Here, it is assumed that the processor 11 receives the parameter information of “Cloud Enable” and the parameter information of “SSL Communication”.

The processor 11 displays the “question sentence” of the parameter information of “Cloud Enable” in a display area 63A. The processor 11 displays the “option” of the parameter information of “Cloud Enable” in a display area 64A.

The processor 11 displays the “question sentence” of the parameter information of “SSL Communication” in a display area 63B. The processor 11 displays the “option” of the parameter information of “SSL Communication” in a display area 64B.

Here, the processor 11 displays a check box in the display area 64. The processor 11 receives the input of the parameter value by receiving a check on the check box.

Then, the processor 11 has a function of generating a setting file which can be set in the MFP 30 or 40 based on the input parameter value.

For example, the processor 11 generates the setting file conforming to a file format readable by the MFP 30 or 40. Here, the processor 11 converts the parameter value input as the setting file to XML data.

FIG. 7 is a diagram illustrating an example of the setting file (XML data) generated by the processor 11. As shown in FIG. 7, the setting file shows the parameter value with a parameter tag. For example, the setting file has an element indicating the parameter value between a start tag and an end tag of the parameter.

In the example shown in FIG. 7, the setting file indicates “ON” as the content of “Cloud Enable”. The setting file indicates “OFF” as the content of “SSL Communication”.

The format and content of the setting file are not limited to specific constitution.

The processor 11 stores the generated setting file in the NVM 14.

The processor 11 has a function of transmitting the generated setting file through the second communication section 16 to the MFP 30 or 40.

The processor 11 receives an operation for transmitting the setting file through the operation section 17. In a case of receiving the operation, the processor 11 transmits the setting file generated through the second communication section 16 to the MFP 30 or 40.

The processor 11 establishes the communication with the MFP 30 or 40 at an arbitrary timing before transmitting the setting file. The processor 11 may receive selection of the MFP 30 or 40 that establishes the communication through the operation section 17.

The processor 11 may transmit the setting file generated in the past to the MFP 30 or 40. For example, the processor 11 receives the selection of the setting file stored in the NVM 14 in the past through the operation section 17. The processor 11 may edit the selected setting file. For example, the processor 11 may receive an editing operation by displaying a screen for editing the setting file. The processor 11 transmits the edited setting file or the setting file which is not edited to the MFP 30 or 40.

The functions realized by the MFPs 30 and 40 are described. Here, the functions realized by the MFP 30 are described. The functions realized by the MFP 40 are the same as those by the MFP 30, and thus the description thereof is omitted.

The following functions are realized by executing the program stored in the ROM 32 or the NVM 34 or the like by the processor 31 of the MFP 30.

The processor 31 has a function of performing the setting according to the setting file.

The processor 31 receives the setting file from the user terminal 10 through the communication section 36. The processor 31 sets the processor 31 according to the received setting file. For example, the processor 31 extracts the parameter and the parameter value from the setting file and reflects the setting. For example, the processor 31 stores the parameter and the parameter value in the NVM 34 in association with each other.

Next, an example of the operation of the setting system 1 is described here, it is assumed that the user performs the same setting for the MFPs 30 and 40.

First, the user inputs the “function name” to the user terminal 10 (ACT 11). The user terminal 10 transmits a request including the input “function name” to the server 20 (ACT 12). The server 20 retrieves the parameter information corresponding to the “function name” included in the request from the parameter table (ACT 13).

In a case of retrieving the parameter information, the server 20 transmits the parameter information as a response to the user terminal 10 (ACT 14). The user terminal 10 generates the input screen for inputting the parameter indicated by the parameter information according to the received parameter information (ACT 15). If the input screen is generated, the user terminal 10 displays the input screen on the display section 18 (ACT 16).

The user inputs the parameter value in the input screen (ACT 17). The user terminal 10 generates the setting file based on the input parameter value (ACT 18). The user inputs an operation of transmitting the setting file to the MFP 30 to the user terminal 10 (ACT 19).

The user terminal 10 transmits the setting file to the MFP 30 according to the input operation (ACT 20). The MFP 30 sets the MFP 30 according to the received setting file (ACT 21).

The user inputs the operation of transmitting the setting file to the MFP 40 to the user terminal 10 (ACT 22). The user terminal 10 transmits the setting file to the MFP 40 according to the input operation (ACT 23). The MFP 40 sets the MFP 40 according to the received setting file (ACT 24).

If the MFP 40 sets the MFP 40, the setting system 1 ends the operation.

Next, an example of the operation of the user terminal 10 is described.

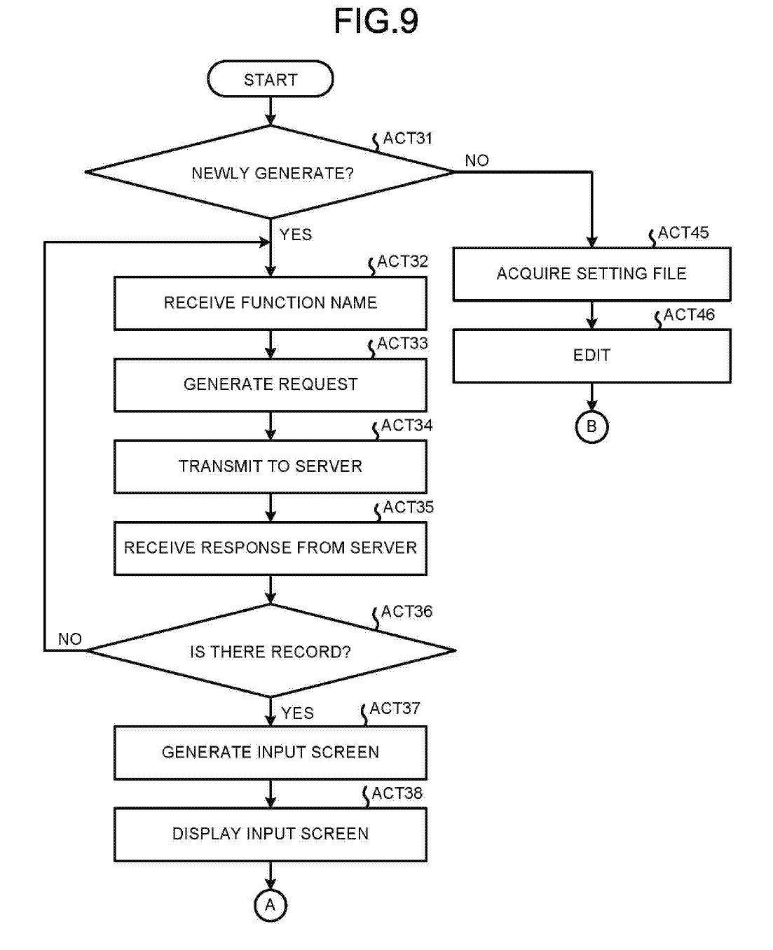

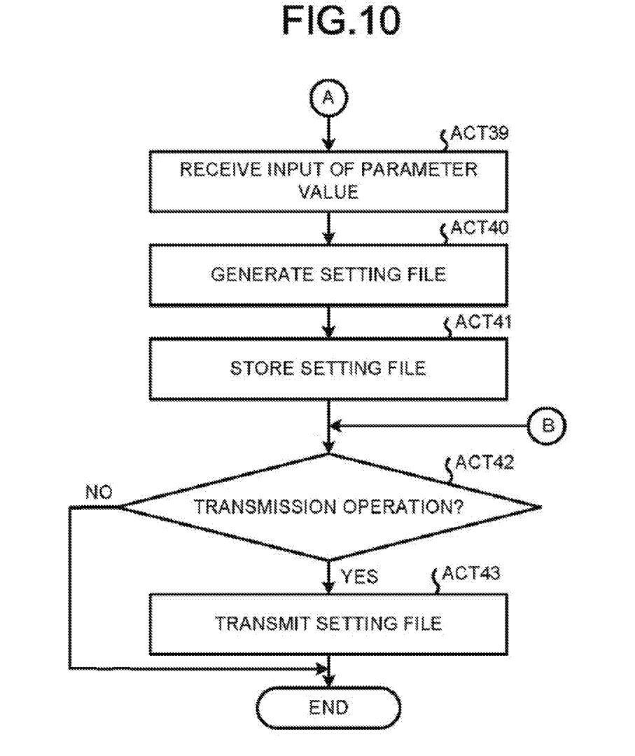

FIG. 9 and FIG. 10 are flowcharts illustrating the example of the operation of the user terminal 10.

First, the processor 11 of the user terminal 10 determines whether to generate the setting file anew (ACT 31). For example, the processor 11 determines whether an operation for newly generating the setting file is received through the operation section 17 (ACT 31).

If determining that the setting file is newly generated (Yes in ACT 31), the processor 11 receives the input of the “function name” through the operation section 17 (ACT 32). If the input of the “function name” is received, the processor 11 generates a request for acquiring the parameter information corresponding to the “function name” (ACT 33).

If the request is generated, the processor 11 transmits the generated request through the first communication section 15 to the server 20 (ACT 34). If the request is transmitted to the server 20, the processor 11 receives the response to the request through the first communication section 15 (ACT 35).

If the response is received, the processor 11 determines whether the response contains a record (the parameter information) (ACT 36). If determining that there is no record in the response (i.e., there is no parameter corresponding to the “function name”) (No in ACT 36), the processor 11 returns to the processing in ACT 32.

If determining that the response includes the record (Yes in ACT 36), the processor 11 generates the input screen to input the parameter value according to the parameter information of the response (ACT 37). If the input screen is generated, the processor 11 displays the generated input screen on the display section 18 (ACT 38).

If the input screen is displayed, the processor 11 receives the input of the parameter value through the operation section 17 (ACT 39). If the input of the parameter value is received, the processor 11 generates the setting file based on the input parameter value (ACT 40).

If the setting file is generated, the processor 11 stores the generated setting file in the NVM 14 (ACT 41). If the setting file is stored in the NVM 14, the processor 11 determines whether the operation of transmitting the setting file is received through the operation section 17 (ACT 42).

If determining that the operation of transmitting the setting file is not received (No in ACT 42), the processor 11 returns to the processing in ACT 42.

If determining that the operation of transmitting the setting file is received (Yes in ACT 42), the processor 11 transmits the setting file to the MFP 30 or 40 via the second communication section 16 (ACT 43).

If the setting file is transmitted to the MFP 30 or 40, the processor 11 ends the operation.

If determining that the setting file is not newly generated (using the setting file generated in the past) (No in ACT 31), the processor 11 acquires the setting file generated in the past from the NVM. 14 (ACT 45). If there is a plurality of the setting files generated in the past, the processor 11 may receive an operation of selecting the setting file for use.

If the setting file is acquired, the processor 11 edits the setting file (ACT 46). For example, the processor 11 receives the editing operation by displaying the screen for receiving the editing.

If the setting file is edited, the processor 11 proceeds to the processing in ACT 42.

The processor 11 does not have to execute the processing in ACT 46.

The setting system 1 may perform setting for devices other than the MFPs 30 and 40. For example, the setting system 1 may perform setting for a PC, an IoT (Internet of Things) terminal, a wearable terminal, or the like. The device to which the setting system performs the setting is not limited to a specific constitution.

In the setting system constituted as described above, the parameter associated with the function set by the user is acquired from the server. The setting system receives the input of the parameter value relating to the acquired parameter from the user. The setting system performs the setting for the MFP using the setting file according to the input parameter value.

Therefore, the setting system can prevent omission from occurring in the input of the necessary parameter. Therefore, the setting system can perform the setting effectively.

The setting system stores the generated setting file. The setting system also performs the setting for other MFPs using the stored setting file. Therefore, the setting system can easily set the same parameter or the parameter value for a plurality of MFPs.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A non-transitory readable storage medium storing a program for enabling a processor of a user terminal to:
receive an input of a function name of an image processing apparatus which is a setting target;
acquire parameter information indicating a parameter associated with the function name input from an external device, the parameter information is composed of a question sentence and a plurality of options associated with the function name, the plurality of options presented to a user in association with a plurality of values of the parameter;
display the question sentence and the plurality of options of the parameter information;
receive an input of a parameter value of the plurality of values in association with an option selected from the plurality of options; and
set the image processing apparatus in response to the parameter value.

2. (canceled)

3. The non-transitory readable storage medium according to claim 1, wherein the image processing apparatus is an image forming apparatus.

4. (canceled)

5. The non-transitory readable storage medium according to claim 1, wherein the information indicating the function is a function name.

6. (canceled)

7. The non-transitory readable storage medium according to claim 1 wherein the program enables the processor to generate XML data based on the parameter value and transmit the XML data to the image processing apparatus.

8. The non-transitory readable storage medium according to claim 1 wherein the program enables the processor to establish an ad hoc communication with the image processing apparatus.

9. A setting method, comprising:
receiving, by a processor of a terminal, an input of a function name of an image processing apparatus which is a setting target;
acquiring, by the processor, parameter information indicating a parameter associated with the function name input from an external device, the parameter information is composed of a Question sentence and a plurality of options associated with the function name, the plurality of options presented to a user in association with a plurality of values of the parameter;
displaying, by the processor, the question sentence and the plurality of options of the parameter information;
receiving, by the processor, an input of a parameter value of the plurality of values in association with an option selected from the plurality of options; and
setting, by the processor, the image processing apparatus in response to the input parameter value.

10-11. (canceled)

12. The method according to claim 9, wherein the information indicating the function is a function name.

13. (canceled)

14. The method according to claim 9, further comprising: generating XML data based on the parameter value and transmitting the XML data to the image processing apparatus.

15. The method according to claim 9, further comprising: establishing an ad hoc communication with the image processing apparatus.

16. A system comprising a terminal and an information processing apparatus, wherein the information processing apparatus comprises:
a first transmitter and a first receiver that transmits and receives data to and from the terminal; and
a processor of the terminal that receives a request for acquiring parameter information indicating a parameter associated with a function from the terminal, acquire parameter information in response to the request, and transmits the parameter information to the terminal, and the terminal comprises:
a second transmitter and second receiver that receives data to and from the information processing apparatus; and
a processor that receives an input of a function name of the image processing apparatus which is a setting target, transmits a request of acquiring parameter information indicating a parameter associated with the function name input from an external device to the information processing apparatus, the parameter information is composed of a question sentence and a plurality of options associated with the function name, the plurality of options presented to a user in association with a plurality of values of the parameter, displays the question sentence and the plurality of options of the parameter information, receives the parameter information from the information processing apparatus, receives an input of a parameter value of the plurality of values in association with an option selected from the plurality of options, and sets the image processing apparatus in response to the parameter value.

17-18. (canceled)

19. The system according to claim 16, wherein the information indicating the function is a function name.

20. (canceled)
